(19) United States
(12) Patent Application Publication
(10) Pub. No.: US 2026/0330889 A1
(43) Pub. Date: Oct. 22, 2026

(54) MANAGEMENT DEVICE, IN-VEHICLE DEVICE, MANAGEMENT METHOD, AND MANAGEMENT PROGRAM

(71) Applicants: SUMITOMO ELECTRIC INDUSTRIES, LTD., Osaka-shi, Osaka (JP); AUTONETWORKS TECHNOLOGIES, LTD., Yokkaichi-shi, Mie (JP); SUMITOMO WIRING SYSTEMS, LTD., Yokkaichi-shi, Mie (JP)

(72) Inventor: Junji YANO, Osaka-shi, Osaka (JP)

(73) Assignees: SUMITOMO ELECTRIC INDUSTRIES, LTD., Osaka-shi, Osaka (JP); AUTONETWORKS TECHNOLOGIES, LTD., Yokkaichi-shi, Mie (JP); SUMITOMO WIRING SYSTEMS, LTD., Yokkaichi-shi, Mie (JP)

(21) Appl. No.: 19/114,793

(22) PCT Filed: Oct. 16, 2023
(86) PCT No.: PCT/JP2023/037376

§ 371 Date: Mar. 25, 2025

(30) Foreign Application Priority Data
Dec. 1, 2022 (JP) 2022-192764

(51) Int. Cl. G07C 5/00

(52) U.S. Cl. CPC G07C 5/008

(57) ABSTRACT

A management device includes: a reception unit configured to receive vehicle identification information for identifying a vehicle, from an in-vehicle device installed in the vehicle; a setting unit configured to perform a setting process of setting a computer program corresponding to the vehicle identification information received by the reception unit, as a first computer program for processing, in the management device, vehicle information regarding the vehicle; and an update request unit configured to perform an update requesting process of transmitting, to the in-vehicle device, update request information for requesting update to a second computer program that corresponds to the vehicle identification information received by the reception unit, and is for the in-vehicle device to perform a transmission process of acquiring the vehicle information and transmitting the vehicle information having been acquired, to the management device so as to be provided to the first computer program set by the setting unit.

### TECHNICAL FIELD

The present disclosure relates to a management device, an in-vehicle device, a management method, and a management program. This application claims priority on Japanese Patent Application No. 2022-192764 filed on Dec. 1, 2022, the entire content of which is incorporated herein by reference,

### BACKGROUND ART

A system including a management device that collects vehicle information regarding a vehicle from an in-vehicle device installed in the vehicle has been developed. For example, International Publication No. WO2020/049379 (PATENT LITERATURE 1) discloses a technology as below. That is, the information collection device is an information collection device that forms a train apparatus management system that manages use history of apparatuses mounted on a train together with a ground system. The information collection device includes: a vehicle information collection unit configured to collect an individual identification number that is uniquely assigned to each management-target apparatus mounted on the train and that identifies the apparatus, and first running information indicating an operation state of each apparatus; and a train integrated management device configured to perform control of collecting second running information indicating an operation state at the time of control of each apparatus, the individual identification number of each apparatus, running information including the first running information and the second running information, a car number that identifies the vehicle on which each apparatus is mounted, and a formation number that identifies the train, and of transmitting such collected information to the ground system via a communication device.

### CITATION LIST

### Patent Literature

PATENT LITERATURE 1: International Publication No. WO2020/049379

PATENT LITERATURE 2: Japanese Laid-Open Patent Publication No. 2019-117493

### SUMMARY OF THE INVENTION

A management device includes: a reception unit configured to receive vehicle identification information for identifying a vehicle, from an in-vehicle device installed in the vehicle; a setting unit configured to perform a setting process of setting a computer program corresponding to the vehicle identification information received by the reception unit, as a first computer program for processing, in the management device, vehicle information regarding the vehicle; and an update request unit configured to perform an update requesting process of transmitting, to the in-vehicle device, update request information for requesting update to a second computer program that corresponds to the vehicle identification information received by the reception unit, and that is for the in-vehicle device to perform a transmission process of acquiring the vehicle information and transmitting the vehicle information having been acquired, to the management device so as to be provided to the first computer program set by the setting unit.

### BRIEF DESCRIPTION OF DRAWINGS

FIG. 1 shows a configuration of a communication system according to an embodiment of the present disclosure.

FIG. 2 shows a configuration of an in-vehicle device according to the embodiment of the present disclosure.

FIG. 3 shows a configuration of a server according to the embodiment of the present disclosure.

FIG. 4 shows an example of a setting status table stored in the server according to the embodiment of the present disclosure.

FIG. 5 shows an example of a contact table stored in the server according to the embodiment of the present disclosure.

FIG. 6 shows an example of a management table stored in the server according to the embodiment of the present disclosure.

FIG. 7 shows an example of a contact table updated by the server according to the embodiment of the present disclosure.

FIG. 8 shows an example of a setting status table updated by the server according to the embodiment of the present disclosure.

FIG. 9 shows another example of a setting status table updated by the server according to the embodiment of the present disclosure.

FIG. 10 is a flowchart of the operation procedure of a setting process and an update process performed by the server according to the embodiment of the present disclosure.

FIG. 11 is a flowchart of the operation procedure of a process performed by the in-vehicle device according to the embodiment of the present disclosure.

FIG. 12 shows an example of the sequence of processes performed by the server, the in-vehicle device, and a terminal device in the communication system according to the embodiment of the present disclosure.

FIG. 13 shows another example of the sequence of processes performed by the server, the in-vehicle device, and the terminal device in the communication system according to the embodiment of the present disclosure.

### DETAILED DESCRIPTION

### Problems to be Solved by the Present Disclosure

When in-vehicle devices are retrofitted after shipment of a vehicle, various functions can be added to the vehicle. In addition, the installation destination of an in-vehicle device may be changed by a user of the vehicle, for example.

Since there is a wide variety of vehicles to which an in-vehicle device is to be retrofitted and vehicles to serve as new installation destinations of an in-vehicle device, it is not easy to maintain compatibility as a system so as to be able to collect vehicle information. In addition, since the in-vehicle device can be interchanged between various vehicles, management of, for example, association between the in-vehicle device, the vehicle, and the user of the vehicle is complicated.

The present disclosure has been made in order to solve the above-described problem. An object of the present disclosure is to provide a management device, an in-vehicle device, a management method, and a management program that can more assuredly collect vehicle information of the installation destination from an in-vehicle device.

### Effects of the Present Disclosure

According to the present disclosure, vehicle information of the installation destination can be more assuredly collected from an in-vehicle device.

### Outline of Embodiment of the Present Disclosure

Hereinafter, an outline of the embodiment of the present disclosure will be listed and described.

(1) A management device according to an embodiment of the present disclosure includes: a reception unit configured to receive vehicle identification information for identifying a vehicle, from an in-vehicle device installed in the vehicle; a setting unit configured to perform a setting process of setting a computer program corresponding to the vehicle identification information received by the reception unit, as a first computer program for processing, in the management device, vehicle information regarding the vehicle; and an update request unit configured to perform an update requesting process of transmitting, to the in-vehicle device, update request information for requesting update to a second computer program that corresponds to the vehicle identification information received by the reception unit, and that is for the in-vehicle device to perform a transmission process of acquiring the vehicle information and transmitting the vehicle information having been acquired, to the management device so as to be provided to the first computer program set by the setting unit.

Thus, with the configuration in which the first computer program corresponding to the vehicle identification information from the vehicle is set in the management device and update request information for requesting update to the second computer program corresponding to the vehicle identification information is transmitted to the in-vehicle device, even when the in-vehicle device has been installed after shipment of the vehicle, and even when the installation destination of the in-vehicle device has been changed, acquisition and the transmission process of the vehicle information can be performed in the in-vehicle device, and the vehicle information received from the in-vehicle device can be processed in the management device. Therefore, the vehicle information of the installation destination can be more assuredly collected from the in-vehicle device.

(2) In (1) above, the reception unit may receive changed-identification information transmitted from the in-vehicle device of which an installation destination has been changed, the changed-identification information being the vehicle identification information for identifying the vehicle in which the in-vehicle device is installed,
the setting unit may set a computer program corresponding to the changed-identification information, as a third computer program for processing, in the management device, vehicle information regarding the vehicle in which the in-vehicle device is installed, and
the update request unit may transmit, to the in-vehicle device, the update request information for requesting update to a fourth computer program that corresponds to the changed-identification information, and that is for the in-vehicle device to perform a transmission process of acquiring the vehicle information and transmitting the vehicle information having been acquired, to the management device so as to be provided to the third computer program set by the setting unit.

With this configuration, even when the installation destination of the in-vehicle device has been changed, the vehicle information of the new installation destination can be more assuredly collected from the in-vehicle device.

(3) In (2) above, when a configuration of a pre-change network being an in-vehicle network in the vehicle before the installation destination has been changed and a configuration of a post-change network being the in-vehicle network in the vehicle after the installation destination has been changed are different from each other, the setting unit may set a computer program corresponding to the changed-identification information as the third computer program, and
when the configuration of the pre-change network and the configuration of the post-change network are different from each other, the update request unit may transmit, to the in-vehicle device, the update request information for requesting update to the fourth computer program corresponding to the changed-identification information.

With this configuration, even when the in-vehicle network configuration in the vehicle of the new installation destination of the in-vehicle device is different from the in-vehicle network configuration in the vehicle before the installation destination of the in-vehicle device has been changed, the vehicle information of the new installation destination can be more assuredly collected from the in-vehicle device.

(4) In any one of (1) to (3) above, the management device may further include a transmission unit configured to transmit, to the in-vehicle device, permission information indicating permission of execution of the transmission process by the in-vehicle device, when the setting process by the setting unit has been completed and the reception unit has received, from the in-vehicle device, update completion information indicating that update to the second computer program has been completed.

With this configuration, after completion of the update to the second computer program has been confirmed, desired vehicle information can be assuredly transmitted from the in-vehicle device to the management device, and vehicle information having appropriate contents can be processed in the management device.

(5) In any one of (1) to (4) above, the reception unit may further receive, from the in-vehicle device, device identification information for identifying the in-vehicle device, and the management device may further include: a storage unit configured to store user correspondence information indicating a correspondence relationship between user identification information for identifying a user of the vehicle and the vehicle identification information, and device correspondence information indicating a correspondence relationship between the device identification information and the vehicle identification information, and a transmission unit configured to, when received-identification information being the device identification information received by the reception unit is not registered in the device correspondence information, transmit, based on the user correspondence information in the storage unit, installation information indicating that the in-vehicle device having the received-identification information has been installed in the vehicle, to the user identified by the user identification information corresponding to the vehicle identification information received by the reception unit.

With this configuration, the installation of the in-vehicle device indicated by the installation information from the management device can be confirmed by the user of the vehicle of the installation destination of the in-vehicle device. Therefore, security can be improved.

(6) In (5) above, the setting unit may perform the setting process when the reception unit has received, as response information from the user to the installation information, approval information indicating that connection between the vehicle and the in-vehicle device having the received-identification information is approved, and the update request unit may perform the update requesting process when the reception unit has received the approval information.

With this configuration, with respect to the in-vehicle device approved by the user of the vehicle, setting of the first program and update of the second program can be performed and the vehicle information of the vehicle can be collected. Therefore, security can be further improved.

(7) In any one of (1) to (6) above, the reception unit may further receive, from the in-vehicle device, device identification information for identifying the in-vehicle device, the management device may further include a storage unit configured to store device correspondence information indicating a correspondence relationship between the device identification information and the vehicle identification information, the setting unit may perform the setting process when received-identification information being the device identification information received by the reception unit is not registered in the device correspondence information, and the update request unit may perform the update requesting process when the received-identification information is not registered in the device correspondence information.

With this configuration, with respect to an in-vehicle device that was installed in a vehicle in the past and for which update to the second computer program has been completed, setting of the first computer program and update of the second computer program can each be inhibited from being redundantly performed.

(8) An in-vehicle device according to the embodiment of the present disclosure is an in-vehicle device configured to perform transmission and reception of information to and from the management device above in any one of (1) to (7) above. The in-vehicle device includes: an acquisition unit configured to acquire the vehicle identification information for identifying the vehicle in which the in-vehicle device is installed; an update unit configured to perform, based on the update request information received from the management device, an update process of updating a computer program stored in the in-vehicle device and for performing the transmission process, to the second computer program corresponding to the vehicle identification information acquired by the acquisition unit; and a transmission processing unit configured to perform the transmission process by executing the second computer program. When having completed the update process, the update unit transmits update completion information to the management device.

With this configuration, even when an in-vehicle device is installed after shipment of a vehicle, and even when the installation destination of the in-vehicle device has been changed, acquisition and transmission of the vehicle information can be performed in the in-vehicle device. Therefore, the vehicle information of the installation destination can be more assuredly collected from the in-vehicle device. In addition, completion of the update of the second computer program can be easily confirmed in the management device.

(9) An in-vehicle device according to the embodiment of the present disclosure is installed in a vehicle and configured to perform transmission and reception of information to and from a management device. The in-vehicle device includes: an acquisition unit configured to acquire vehicle identification information for identifying the vehicle in which the in-vehicle device is installed; an update unit configured to perform, based on update request information received from the management device, the update request information being for requesting update to a computer program for the in-vehicle device to perform a transmission process of acquiring vehicle information regarding the vehicle and transmitting the vehicle information to the management device, an update process of updating the computer program stored in the in-vehicle device to a new computer program that corresponds to the vehicle identification information acquired by the acquisition unit and that is for performing the transmission process; and a transmission processing unit configured to perform the transmission process by executing the computer program having been updated. When having completed the update process, the update unit transmits update completion information to the management device.

With this configuration, even when an in-vehicle device is installed after shipment of a vehicle, and even when the installation destination of the in-vehicle device has been changed, acquisition and transmission of the vehicle information can be performed in the in-vehicle device. Therefore, the vehicle information of the installation destination can be more assuredly collected from the in-vehicle device. In addition, completion of the update of the computer program can be easily confirmed in the management device.

(10) A management method according to the embodiment of the present disclosure is to be performed in a management device. The management method includes: a step of receiving vehicle identification information for identifying a vehicle, from an in-vehicle device installed in the vehicle; a step of performing a setting process of setting a computer program corresponding to the vehicle identification information having been received, as a first computer program for processing, in the management device, vehicle information regarding the vehicle; and a step of performing an update requesting process of transmitting, to the in-vehicle device, update request information for requesting update to a second computer program that corresponds to the vehicle identification information having been received, and that is for the in-vehicle device to perform a transmission process of acquiring the vehicle information and transmitting the vehicle information having been acquired, to the management device so as to be provided to the first computer program set in the management device.

Thus, with the configuration in which the first computer program corresponding to the vehicle identification information from the vehicle is set in the management device and update request information for requesting update to the second computer program corresponding to the vehicle identification information is transmitted to the in-vehicle device, even when the in-vehicle device has been installed after shipment of the vehicle, and even when the installation destination of the in-vehicle device has been changed, acquisition and the transmission process of the vehicle information can be performed in the in-vehicle device, and the vehicle information received from the in-vehicle device can be processed in the management device. Therefore, the vehicle information of the installation destination can be more assuredly collected from the in-vehicle device.

(11) A management program according to the embodiment of the present disclosure is to be used in a management device. The management program causes a computer to function as: a reception unit configured to receive vehicle identification information for identifying a vehicle, from an in-vehicle device installed in the vehicle; a setting unit configured to perform a setting process of setting a computer program corresponding to the vehicle identification information received by the reception unit, as a first computer program for processing, in the management device, vehicle information regarding the vehicle; and an update request unit configured to perform an update requesting process of transmitting, to the in-vehicle device, update request information for requesting update to a second computer program that corresponds to the vehicle identification information received by the reception unit, and that is for the in-vehicle device to perform a transmission process of acquiring the vehicle information and transmitting the vehicle information having been acquired, to the management device so as to be provided to the first computer program set by the setting unit.

Thus, with the configuration in which the first computer program corresponding to the vehicle identification information from the vehicle is set in the management device and update request information for requesting update to the second computer program corresponding to the vehicle identification information is transmitted to the in-vehicle device, even when the in-vehicle device has been installed after shipment of the vehicle, and even when the installation destination of the in-vehicle device has been changed, acquisition and the transmission process of the vehicle information can be performed in the in-vehicle device, and the vehicle information received from the in-vehicle device can be processed in the management device. Therefore, the vehicle information of the installation destination can be more assuredly collected from the in-vehicle device.

An aspect of the present disclosure can be realized not only as a management device including such a characteristic processing unit but also as a semiconductor integrated circuit that realizes a part or the entirety of the management device or as a system including the management device.

### Details of Embodiment of the Present Disclosure

Hereinafter, an embodiment of the present disclosure will be described with reference to the drawings. In the drawings, the same or corresponding parts are denoted by the same reference signs, and descriptions thereof are not repeated. At least some parts of the embodiments described below can be combined together as desired.

### Communication System

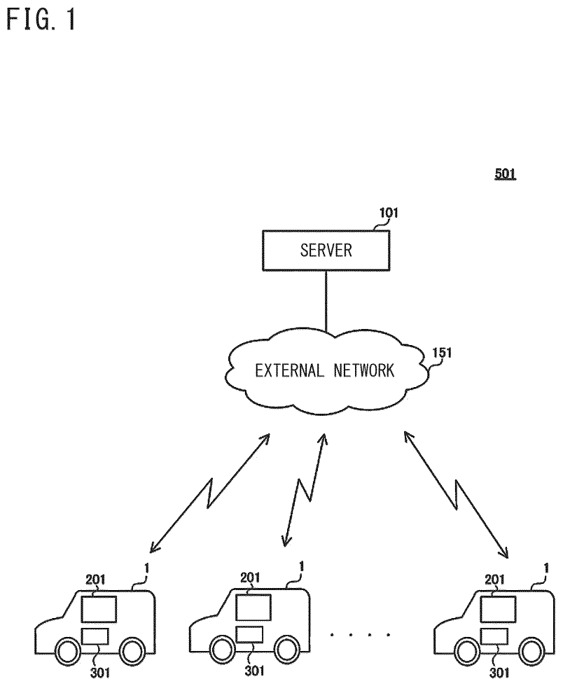

FIG. 1 shows a configuration of a communication system according to an embodiment of the present disclosure. With reference to FIG. 1, a communication system 501 includes a server 101, one or a plurality of in-vehicle devices 201, and one or a plurality of terminal devices 301. The server 101 and each in-vehicle device 201 perform transmission and reception of information via an external network 151 such as the Internet, for example. The server 101 and each terminal device 301 perform transmission and reception of information via the external network 151, for example. The in-vehicle device 201 is installed in a vehicle 1. The server 101 is an example of a management device.

The server 101 and the terminal device 301 are used by a business entity that manages operation of the vehicle 1, or an individual, for example. The terminal device 301 is a communication terminal device such as a smartphone or a tablet, for example.

The server 101 receives, from one or a plurality of in-vehicle devices 201, vehicle information regarding a corresponding vehicle 1.

The server 101 performs an analysis process of analyzing the vehicle information received from the in-vehicle device 201. Specifically, the server 101 performs the analysis process by executing a server-side program for processing the vehicle information.

The terminal device 301 receives inputs of various types of information from a user of the vehicle 1, for example, and transmits the received various types of information to the in-vehicle device 201. The terminal device 301 may transmit the various types of information received from the user of the vehicle 1, to the server 101 via the external network 151.

### In-Vehicle Device

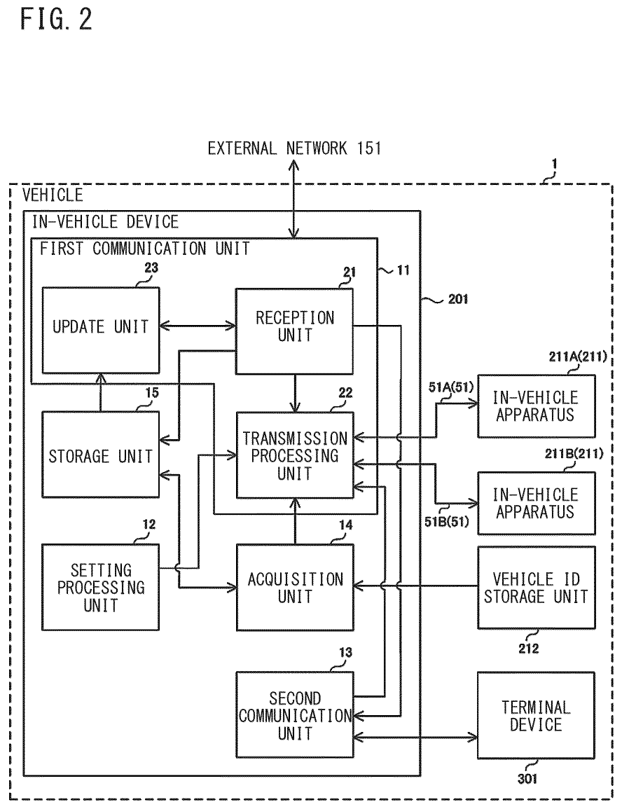

FIG. 2 shows a configuration of an in-vehicle device according to the embodiment of the present disclosure. With reference to FIG. 2, the in-vehicle device 201 is connected to a plurality of in-vehicle apparatuses 211 via a CAN bus 51 according to the standard of CAN (Controller Area Network) (registered trademark), for example.

The in-vehicle apparatus 211 is an automated driving ECU (Electronic Control Unit), an engine ECU, a door lock ECU, a TCU (Telematics Communication Unit), a sensor, a navigation device, a human machine interface, or a camera, for example.

In the example shown in FIG. 2, the in-vehicle device 201 is connected to in-vehicle apparatuses 211A, 211B, which are a plurality of in-vehicle apparatuses 211.

The in-vehicle device 201 includes a first communication unit 11, a setting processing unit 12, a second communication unit 13, an acquisition unit 14, and a storage unit 15. The first communication unit 11 includes a reception unit 21, a transmission processing unit 22, and an update unit 23. A part or the entirety of the first communication unit 11, the setting processing unit 12, the second communication unit 13, and the acquisition unit 14 is realized by processing circuitry including one or a plurality of processors, for example. The storage unit 15 is a non-volatile memory included in the above processing circuitry, for example.

### First Communication Unit

The first communication unit 11 performs wireless communication with a wireless base station (not shown) in accordance with a communication method such as WiFi (registered trademark), LTE (Long Term Evolution) (registered trademark), or 5G, to perform communication with the server 101 via the external network 151. The first communication unit 11 need not necessarily be configured to communicate with the server 101 via a wireless base station and the external network 151 and may be configured to communicate with the server 101 via a wired line. The first communication unit 11 may be configured to communicate with the server 101 further via another in-vehicle device.

The transmission processing unit 22 in the first communication unit 11 performs a transmission process of acquiring vehicle information regarding the vehicle 1 and transmitting the vehicle information to the server 101. The vehicle information includes information regarding travel of the vehicle 1, for example.

Specifically, the transmission processing unit 22 acquires position information, vehicle speed information, and the like of the vehicle 1, for example. The vehicle information is not limited to the position information and the vehicle speed information and may be driving control information such as a brake operation and a steering operation in the vehicle 1. The vehicle information is not limited to information regarding travel of the vehicle 1 and may be information indicating an image captured by a camera installed in the vehicle 1, and information indicating a measurement result from a sensor installed in the vehicle 1.

The transmission processing unit 22 performs communication according to the CAN standard between one or a plurality of in-vehicle apparatuses 211, for example.

In the example shown in FIG. 2, the transmission processing unit 22 is connected to each of the in-vehicle apparatuses 211A, 211B via the CAN buses 51A, SIB, which are two CAN buses 51. The in-vehicle device 201 need not be configured such that two CAN buses 51 are connected to the transmission processing unit 22 and may be configured such that one or a plurality of the CAN buses 51 are connected to the transmission processing unit 22.

The in-vehicle device 201 and each in-vehicle apparatus 211 need not necessarily be based on CAN and may be configured to perform communication according to the standard of CAN FD (CAN with Flexible Data Rate), Ethernet (registered trademark), FlexRay (registered trademark), MOST (Media Oritend System Transport) (registered trademark), LIN (Local Interconnect Network), or the like.

The in-vehicle apparatus 211 transmits vehicle information thereof to the in-vehicle device 201. Vehicle information that is transmitted from each in-vehicle apparatus 211 via the CAN bus 51 is stored into a CAN frame having assigned thereto a CAN-ID (Identifier) indicating the type and the like of data.

The storage unit 15 stores a vehicle-side program for the in-vehicle device 201 to perform a transmission process. The transmission processing unit 22 performs the transmission process by executing the vehicle-side program stored in the storage unit 15.

### Setting Processing Unit

The setting processing unit 12 performs a data setting process regarding transmission of the vehicle information. For example, the setting processing unit 12 sets the type of the vehicle information to be transmitted to the server 101, as the data setting process.

In the following, an example in which, in the in-vehicle device 201 to which the setting processing unit 12 belongs, the setting processing unit 12 performs setting such that the vehicle information of the in-vehicle apparatus 211A is transmitted to the server 101, will be described. Here, it is assumed that the CAN-ID of the CAN frame in which the vehicle information of the in-vehicle apparatus 211A is stored is “001”.

When the transmission processing unit 22 periodically or non-periodically acquires the vehicle information transmitted from the in-vehicle apparatus 211A, the setting processing unit 12 performs setting such that the transmission processing unit 22 transmits the vehicle information included in a CAN frame having a CAN-ID “001”, to the server 101.

Meanwhile, when the transmission processing unit 22 does not acquire the vehicle information from the in-vehicle apparatus 211A, the setting processing unit 12 requests transmission of the vehicle information, to the in-vehicle apparatus 211A via the transmission processing unit 22, as the data setting process. Upon reception of the request from the in-vehicle device 201, the in-vehicle apparatus 211A periodically or non-periodically transmits a CAN frame having a CAN-ID “001”, to the in-vehicle device 201. The setting processing unit 12 performs setting such that the transmission processing unit 22 transmits the vehicle information included in the CAN frame having the CAN-ID “001”, to the server 101.

### Second Communication Unit

The second communication unit 13 performs communication according to the communication method based on USB (Universal Serial Bus) with a terminal device 301, for example. The second communication unit 13 and the terminal device 301 may be configured to perform wireless communication according to the standard of Bluetooth (registered trademark) or the like.

The second communication unit 13 transmits vehicle information to the terminal device 301, for example. More specifically, as described above, the transmission processing unit 22 transmits acquired vehicle information to the server 101 and outputs the vehicle information to the second communication unit 13. The second communication unit 13 transmits the vehicle information received from the transmission processing unit 22, to the terminal device 301.

### Server

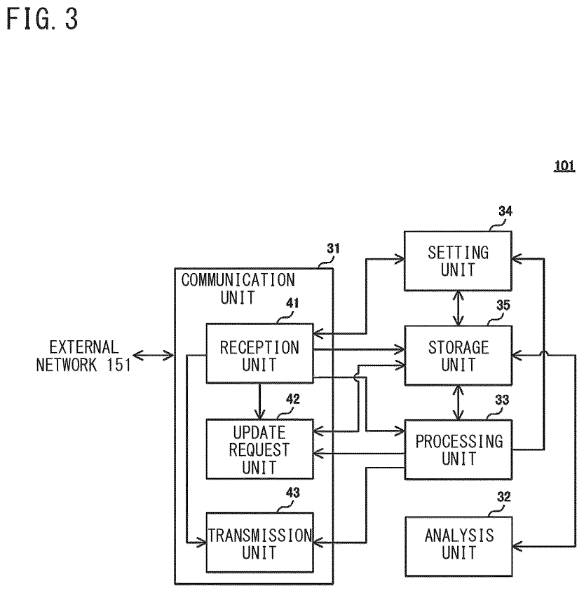

FIG. 3 shows a configuration of a server according to the embodiment of the present disclosure. With reference to FIG. 3, the server 101 includes a communication unit 31, an analysis unit 32, a processing unit 33, a setting unit 34, and a storage unit 35. The communication unit 31 includes a reception unit 41, an update request unit 42, and a transmission unit 43. A part or the entirety of the communication unit 31, the analysis unit 32, the processing unit 33, and the setting unit 34 is realized by processing circuitry including one or a plurality of processors, for example. The storage unit 35 is a non-volatile memory included in the above processing circuitry, for example.

The reception unit 41 receives vehicle information from the in-vehicle device 201. The reception unit 41 stores the vehicle information received from the in-vehicle device 201 into the storage unit 35.

The analysis unit 32 performs an analysis process on the vehicle information received from the in-vehicle device 201, by executing the server-side program. For example, based on the vehicle information received from the in-vehicle device 201, the analysis unit 32 performs various analyses such as detection of an abnormality regarding the vehicle 1.

### Description of Problem

When in-vehicle devices are retrofitted after shipment of a vehicle, various functions can be added to the vehicle. In addition, the installation destination of an in-vehicle device may be changed by a user of the vehicle, for example.

There is a wide variety of vehicles to which an in-vehicle device is to be retrofitted and vehicles to serve as new installation destinations of an in-vehicle device. For example, between vehicles, the configuration of an in-vehicle network may be different.

Specifically, depending on the type of the vehicle, the type of the in-vehicle apparatus to be installed, the type of the communication standard for the in-vehicle device to perform transmission and reception of information to and from the in-vehicle apparatus, and the like may be different. Therefore, even when the in-vehicle device executes the vehicle-side program stored therein after the in-vehicle device has been installed in the vehicle, the in-vehicle device may fail to acquire vehicle information. In this case, the server cannot collect vehicle information from the in-vehicle device and cannot continue the analysis process for the vehicle information. That is, it is not easy to maintain compatibility as a system so as to be able to collect vehicle information.

In the server, since the in-vehicle device can be interchanged between various vehicles, management of, for example, association between the in-vehicle device, the vehicle, and the user of the vehicle is complicated.

In contrast, the communication system 501 according to the embodiment of the present disclosure solves such problems by the configuration and operation as below.

### In-Vehicle Device

With reference to FIG. 2 again, the acquisition unit 14 in the in-vehicle device 201 periodically or non-periodically acquires device identification information (hereinafter, also referred to as “in-vehicle device ID”) for identifying the in-vehicle device 201. For example, when the in-vehicle device 201 has been activated by the ignition power supply of the vehicle 1 being switched from an off-state to an on-state, the acquisition unit 14 acquires the in-vehicle device ID stored in the storage unit 15. The acquisition unit 14 outputs the acquired in-vehicle device ID to the transmission processing unit 22. The in-vehicle device ID is an ID unique to each in-vehicle device 201.

In addition, the acquisition unit 14 periodically or non-periodically acquires vehicle identification information (hereinafter, also referred to as “vehicle ID”) for identifying the vehicle 1 in which the in-vehicle device 201 is installed. The vehicle ID is an ID unique to each vehicle 1.

More specifically, the vehicle 1 includes a vehicle ID storage unit 212 that stores the vehicle ID of the vehicle. For example, when the in-vehicle device 201 has been activated by the ignition power supply of the vehicle I being switched from an off-state to an on-state, the acquisition unit 14 acquires the vehicle ID stored in the vehicle ID storage unit 212. The acquisition unit 14 outputs the acquired vehicle ID to the transmission processing unit 22.

The transmission processing unit 22 transmits ID acquisition information including the vehicle ID and the in-vehicle device ID received from the acquisition unit 14, to the server 101. The vehicle ID may be registered in advance in the storage unit 15 of the in-vehicle device 201 by a dealer or the like, for example. In this case, when the in-vehicle device 201 has been activated, the acquisition unit 14 acquires the vehicle ID stored in the storage unit 15.

### Server

With reference to FIG. 3 again, the reception unit 41 receives the ID acquisition information from the in-vehicle device 201. That is, the reception unit 41 receives the in-vehicle device ID and the vehicle ID from the in-vehicle device 201. The reception unit 41 stores the received ID acquisition information into the storage unit 35, and outputs a notification that the ID acquisition information has been received, to the processing unit 33.

The storage unit 35 stores a setting status table Tb10 including device correspondence information that indicates the correspondence relationship between an in-vehicle device ID and a vehicle ID.

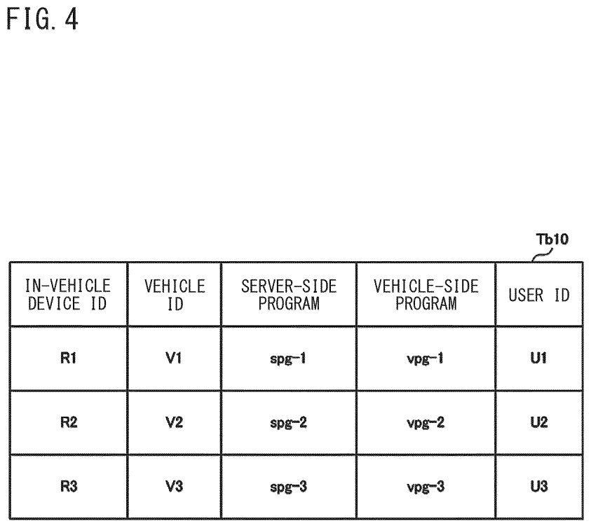

FIG. 4 shows an example of a setting status table stored in the server according to the embodiment of the present disclosure.

In the setting status table Tb 10 shown in FIG. 4, the vehicle ID corresponding to an in-vehicle device ID “R1” is “V1”, the vehicle ID corresponding to an in-vehicle device ID “R2” is “V2”, and the vehicle ID corresponding to an in-vehicle device ID “R3” is “V3”.

Upon reception, from the reception unit 41, of the notification that the ID acquisition information has been received, the processing unit 33 refers to the ID acquisition information and the setting status table Tb10 stored in the storage unit 35. Then, the processing unit 33 performs an ID confirmation process of confirming whether or not the in-vehicle device ID included in the ID acquisition information, i.e., the in-vehicle device ID (hereinafter, also referred to as “received-identification information”) received by the reception unit 41, is registered in the setting status table Tb10.

Here, in the ID confirmation process, the processing unit 33 confirms whether or not a correspondence relationship (hereinafter, also referred to as “ID correspondence relationship”) between the received-identification information and the vehicle ID is registered in the setting status table Tb10. Then, the processing unit 33 notifies the transmission unit 43 of the confirmation result.

### Request for User Information

With reference to FIG. 2 and FIG. 3, upon reception, from the processing unit 33, of a notification that the ID correspondence relationship is not registered in the setting status table Tb10, the transmission unit 43 transmits an information request notification for requesting user information regarding the user of the vehicle 1, to the in-vehicle device 201. The user information includes, for example, user identification information (hereinafter, also referred to as “user ID”) for identifying the user of the vehicle 1, information indicating a contact method with the user, and contact information of the user.

In the in-vehicle device 201, upon reception of the information request notification from the server 101, the reception unit 21 outputs, to the second communication unit 13, a notification that the information request notification has been received.

Upon reception, from the reception unit 21, of the notification that the information request notification has been received, the second communication unit 13 transmits, to the terminal device 301, transmission request information indicating that transmission of the user information to the in-vehicle device 201 is requested.

Upon reception of the transmission request information from the in-vehicle device 201, the terminal device 301 transmits the user information to the in-vehicle device 201.

More specifically, for example, upon reception of the transmission request information from the in-vehicle device 201, the terminal device 301 urges the user of the vehicle 1 to input the user information. Then, upon reception of the input of the user information from the user of the vehicle 1, the terminal device 301 transmits the received user information to the in-vehicle device 201.

The second communication unit 13 outputs the received user information to the transmission processing unit 22. Then, the transmission processing unit 22 transmits the user information received from the second communication unit 13, to the server 101.

In the server 101, upon reception of the user information from the in-vehicle device 201, the reception unit 41 stores the received user information into the storage unit 35, and outputs a notification that the user information has been received, to the processing unit 33.

Upon reception, from the reception unit 41, of the notification that the user information has been received, the processing unit 33 performs, based on the ID acquisition information and the user information stored in the storage unit 35, a user registration process of registering the user ID included in the user information in association with the vehicle ID included in the ID acquisition information, into the setting status table Tb10.

### Contact Table

When the processing unit 33 has received, from the reception unit 41, the notification that the user information has been received, the processing unit 33 performs, based on the ID acquisition information and the user information stored in the storage unit 35, a table update process of updating a contact table Tb20 indicating the correspondence relationship between user information and a vehicle ID included in ID acquisition information. The contact table Tb20 includes user correspondence information indicating the correspondence relationship between a user ID and a vehicle ID.

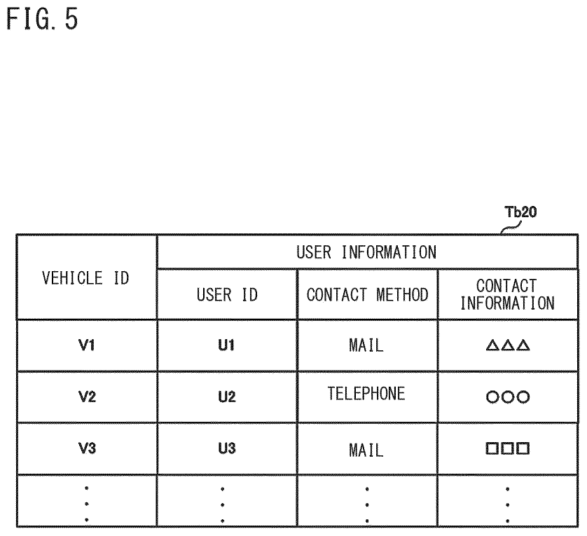

FIG. 5 shows an example of a contact table stored in the server according to the embodiment of the present disclosure.

In the contact table Tb20 shown in FIG. 5, the user information corresponding to a vehicle ID “V1” includes a user ID “U1”, a contact method “mail”, and contact information.

The user information corresponding to a vehicle ID “V2” includes a user ID “U2”, a contact method “telephone”, and contact information. The user information corresponding to a vehicle ID “V3” includes a user ID “U3”, a contact method “mail”, and contact information. The contact table Tb20 may be registered in advance in the storage unit 35 by a dealer or the like, for example.

When having completed the table update process, the processing unit 33 outputs a notification that the contact table Tb20 has been updated, to the transmission unit 43.

Meanwhile, when the ID correspondence relationship is registered in the setting status table Tb10, the processing unit 33 does not perform the user registration process and the table update process.

### Installation Information

With reference to FIG. 3 and FIG. 5, when the received-identification information is not registered in the setting status table Tb10, the transmission unit 43 transmits, based on the user correspondence information in the storage unit 35, installation information indicating that the in-vehicle device 201 having the received-identification information has been installed in the vehicle 1, to the user identified by the user ID corresponding to the vehicle ID received by the reception unit 41.

More specifically, upon reception, from the processing unit 33, of the notification that the contact table Tb20 has been updated, the transmission unit 43 refers to the ID acquisition information and the contact table Tb20 stored in the storage unit 35 and specifies a user ID corresponding to the vehicle ID included in the ID acquisition information. That is, when the ID correspondence relationship is not registered in the setting status table Tb10, the transmission unit 43 refers to the ID acquisition information and the contact table Tb20 stored in the storage unit 35 and specifies a user ID corresponding to the vehicle ID included in the ID acquisition information. Then, according to the contact method corresponding to the user ID included in the contact table Tb20, the transmission unit 43 transmits the installation information to the user having the specified user ID.

Upon reception of the installation information from the server 101, the user determines whether or not to approve connection between the vehicle 1 and the in-vehicle device 201 indicated in the installation information. Then, upon reception of an input of approval information from the user, the terminal device 301 transmits the received approval information to the in-vehicle device 201.

With reference to FIG. 2 again, in the in-vehicle device 201, upon reception of the approval information from the terminal device 301, the second communication unit 13 outputs the received approval information to the transmission processing unit 22. The transmission processing unit 22 transmits the approval information received from the second communication unit 13, to the server 101.

With reference to FIG. 3 again, in the server 101, as response information from the user to the installation information, when the reception unit 41 has received, from the user, the approval information indicating that connection between the vehicle 1 and the in-vehicle device 201 having the received-identification information is approved, the reception unit 41 outputs a notification (hereinafter, also referred to as “approval reception notification”) that the approval information has been received, to the processing unit 33, the setting unit 34, and the update request unit 42.

Upon reception of the approval reception notification from the reception unit 41, the processing unit 33 refers to the ID acquisition information and the setting status table Tb10 stored in the storage unit 35. Then, the processing unit 33 confirms whether or not the in-vehicle device ID included in the ID acquisition information, i.e., the received-identification information, is registered in the setting status table Tb10.

When the received-identification information is registered in the setting status table Tb10, the processing unit 33 determines that the installation destination of the in-vehicle device 201 having the received-identification information has been changed to the vehicle 1 having the vehicle ID received by the reception unit 41. That is, the processing unit 33 determines that the vehicle ID received by the reception unit 41 is the vehicle ID (hereinafter, also referred to as “changed-identification information”) transmitted from the in-vehicle device 201 of which the installation destination has been changed, the vehicle ID being that of the vehicle 1 in which the in-vehicle device 201 is installed.

Meanwhile, when the received-identification information is not registered in the setting status table Tb10, the processing unit 33 determines that the in-vehicle device 201 having the received-identification information is not the one of which the installation destination has been changed, but the one that has been installed in a vehicle for the first time.

Here, it is assumed that the processing unit 33 has confirmed that the received-identification information is not registered in the setting status table Tb10. The processing unit 33 notifies the setting unit 34 and the update request unit 42 of the confirmation result.

### Setting Unit

When the setting unit 34 has received the approval reception notification from the reception unit 41 and has received, from the processing unit 33, a notification (hereinafter, also referred to as “non-registration notification”) that the received-identification information is not registered in the setting status table Tb10, the setting unit 34 selects, from among a plurality of types of server-side programs, a server-side program that should be executed and that corresponds to the vehicle model specified by the vehicle ID received by the reception unit 41. That is, when the reception unit 41 has received the approval information and the received-identification information is not registered in the setting status table Tb10, the setting unit 34 performs a setting process of setting, as the server-side program, a computer program corresponding to the vehicle model specified by the vehicle ID received by the reception unit 41.

For example, in the setting process, the setting unit 34 uses a management table Tb30 including the correspondence relationship between a vehicle ID and a server-side program. The management table Tb30 is stored in the storage unit 35.

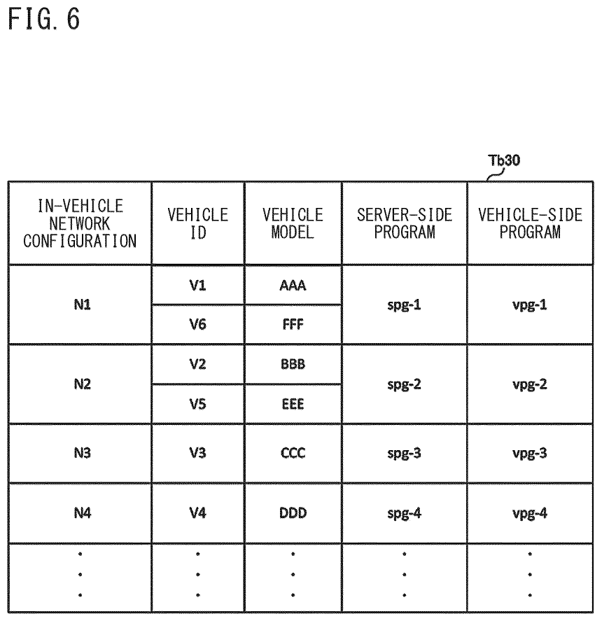

FIG. 6 shows an example of a management table stored in the server according to the embodiment of the present disclosure.

In the management table Tb30 shown in FIG. 6, the server-side program corresponding to a vehicle model “AAA” specified by a vehicle ID “V1” and the server-side program corresponding to a vehicle model “FFF” specified by a vehicle ID “V6” are “spg-1”. The server-side program corresponding to a vehicle model “BBB” specified by a vehicle ID “V2” and the server-side program corresponding to a vehicle model “EEE” specified by a vehicle ID “V5” are “spg-2”. The server-side program corresponding to a vehicle model “CCC” specified by a vehicle ID “V3” is “spg-3”, and the server-side program corresponding to a vehicle model “DDD” specified by a vehicle ID “V4” is “spg-4”. The server-side programs “spg-1”, “spg-2”, “spg-3”, and “spg-4” are examples of a first computer program.

With reference to FIG. 3 and FIG. 6, when the setting unit 34 has received the approval reception notification from the reception unit 41 and has received the non-registration notification from the processing unit 33, the setting unit 34 refers to the ID acquisition information and the management table Tb30 stored in the storage unit 35 and specifies a server-side program corresponding to the vehicle ID included in the ID acquisition information.

The setting unit 34 determines the specified server-side program, as a computer program for processing the vehicle information regarding the vehicle 1 of the vehicle model specified by the vehicle ID received by the reception unit 41. Then, the setting unit 34 registers the specified server-side program in association with the vehicle ID received by the reception unit 41, into the setting status table Tb10 shown in FIG. 4.

For example, as shown in FIG. 4, the server-side program “spg-1” is associated with the vehicle ID “V1”, the server-side program “spg-2” is associated with the vehicle ID “V2”, and the server-side program “spg-3” is associated with the vehicle ID “V3”. “Vehicle-side program” shown in FIG. 4 will be described later.

When having completed the setting process, the setting unit 34 outputs setting completion information to the transmission unit 43.

### Update Request Unit

When the reception unit 41 has received the approval information and the received-identification information is not registered in the setting status table Tb10, the update request unit 42 performs an update requesting process of transmitting, to the in-vehicle device 201, update request information for requesting update to a vehicle-side program for performing the transmission process, the vehicle-side program being a computer program corresponding to the vehicle ID received by the reception unit 41.

More specifically, when the setting unit 34 has received the approval reception notification from the reception unit 41 and has received, from the processing unit 33, a notification that the received-identification information is not registered in the setting status table Tb10, the setting unit 34 performs the update requesting process.

Here, the management table Tb30 in the storage unit 35 includes a correspondence relationship between a vehicle ID and a vehicle-side program.

In the management table Tb30 shown in FIG. 6, the vehicle-side program corresponding to the vehicle IDs “V1” and “V6” is “vpg-1”, the vehicle-side program corresponding to the vehicle IDs “V2” and “V5” are “vpg-2”, the vehicle-side program corresponding to the vehicle ID “V3” is “vpg-3”, and the vehicle-side program corresponding to the vehicle ID “V4” is “vpg-4”. The vehicle-side programs “vpg-1”, “vpg-2”, “vpg-3”, and “vpg-4” are examples of a second computer program.

When the update request unit 42 has received the approval reception notification from the reception unit 41 and has received the non-registration notification from the processing unit 33, the update request unit 42 refers to the ID acquisition information and the management table Tb30 stored in the storage unit 35 and specifies a vehicle-side program corresponding to the vehicle ID included in the ID acquisition information.

Then, the update request unit 42 transmits, to the in-vehicle device 201, update request information including a URL (Uniform Resource Locater) indicating the download source of the specified vehicle-side program, for example. Instead of the above URL, the update request information may include the vehicle-side program corresponding to the vehicle ID received by the reception unit 41.

The update request unit 42 registers the specified vehicle-side program in association with the vehicle ID received by the reception unit 41, into the setting status table Tb10.

For example, as shown in FIG. 4, the vehicle-side program “vpg-1” is associated with the vehicle ID “V1”, the vehicle-side program “vpg-2”is associated with the vehicle ID “V2”, and the vehicle-side program “vpg-3” is associated with the vehicle ID “V3”.

### Update Process Performed by In-Vehicle Device

With reference to FIG. 2 again, based on the update request information received from the server 101, the update unit 23 in the in-vehicle device 201 performs an update process of updating the vehicle-side program stored in the in-vehicle device 201 to a new vehicle-side program (hereinafter, also referred to as “update program”) corresponding to the vehicle ID acquired by the acquisition unit 14.

More specifically, upon receiving the update request information from the server 101, the reception unit 21 outputs the received update request information, to the update unit 23.

Upon reception of the update request information from the reception unit 21, the update unit 23 outputs download request information for requesting download of the update program, to the reception unit 21.

Upon reception of the download request information from the update unit 23, the reception unit 21 accesses the URL included in the update request information received from the server 101 to download the update program.

When having completed the update process, the update unit 23 transmits update completion information to the server 101. More specifically, the reception unit 21 outputs, to the update unit 23, a notification that the update program has been downloaded. Upon reception of the notification from the reception unit 21, the update unit 23 transmits update completion information to the server 101. The reception unit 21 stores the downloaded update program into the storage unit 15.

With reference to FIG. 3 again, in the server 101, upon reception of the update completion information from the in-vehicle device 201, the reception unit 41 outputs, to the transmission unit 43, a notification that the update completion information has been received.

When the transmission unit 43 has received the setting completion information from the setting unit 34 and has received, from the reception unit 41, a notification that the update completion information has been received, the transmission unit 43 transmits, to the in-vehicle device 201, permission information indicating that execution of the transmission process by the in-vehicle device 201 is permitted. That is, when the setting process by the setting unit 34 has been completed and the reception unit 41 has received the update completion information from the in-vehicle device 201, the transmission unit 43 transmits the permission information to the in-vehicle device 201.

With reference to FIG. 2 again, upon reception of the permission information from the server 101, the reception unit 21 outputs, to the transmission processing unit 22, a notification that the permission information has been received. Upon reception, from the reception unit 21, of the notification that the permission information has been received, the transmission processing unit 22 reads out the updated vehicle-side program, i.e., the update program, stored in the storage unit 15. The transmission processing unit 22 performs the transmission process by executing the read-out update program.

### When Installation Destination of In-Vehicle Device has Been Changed

In the following, details of the setting process and the update requesting process performed by the server 101 when the installation destination of the in-vehicle device 201 has been changed, will be described. Here, a case where the installation destination of the in-vehicle device 201 having the in-vehicle device ID “R2” has been changed from the vehicle 1 having the vehicle ID “V2” to the vehicle 1 having the vehicle ID “V4” will be described as specific example 1.

### Specific Example 1

With reference to FIG. 2 and FIG. 3 again, the acquisition unit 14 in the in-vehicle device 201 periodically or non-periodically acquires the in-vehicle device ID thereof, and the vehicle ID of the vehicle 1 (hereinafter, also referred to as “changed vehicle”) serving as a new installation destination.

The acquisition unit 14 outputs ID acquisition information including the in-vehicle device ID thereof and the vehicle ID of the changed vehicle, to the transmission processing unit 22. The transmission processing unit 22 transmits the ID acquisition information received from the acquisition unit 14, to the server 101.

In the server 101, the reception unit 41 stores the ID acquisition information received from the in-vehicle device 201 into the storage unit 35 and outputs a notification that the ID acquisition information has been received, to the processing unit 33.

Upon reception, from the reception unit 41, of the notification that the ID acquisition information has been received, the processing unit 33 performs the above-described “ID confirmation process”.

Then, in the ID confirmation process, when the ID correspondence relationship is not registered in the setting status table Tb10, the processing unit 33 transmits the above-described “information request notification”, to the in-vehicle device 201.

Upon reception of the information request notification from the server 101, the in-vehicle device 201 acquires the above-described “user information” from the terminal device 301 and transmits the “user information” to the server 101.

In the server 101, upon reception, from the reception unit 41, of a notification that the user information has been received, the processing unit 33 performs the process of updating the above-described “contact table Tb20”.

Upon reception, from the reception unit 41, of a notification that the user information has been received, the processing unit 33 updates the contact table Tb20, based on the ID acquisition information and the user information stored in the storage unit 35.

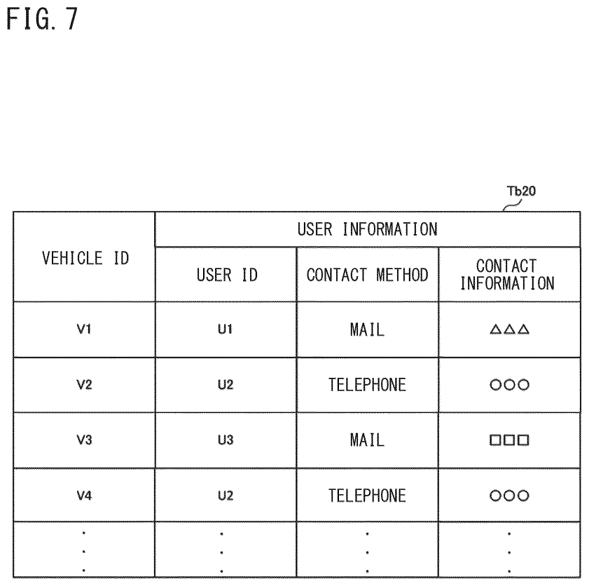

FIG. 7 shows an example of a contact table updated by the server according to the embodiment of the present disclosure.

In the updated contact table Tb20 shown in FIG. 7, the user information corresponding to the vehicle ID “V4” of the changed vehicle includes the user ID “U2”, a contact method “telephone”, and contact information. That is, in the example shown in FIG. 7, the user ID “U2” of the user of the changed vehicle is the same as the user of the vehicle 1 having the vehicle ID “V2” before the installation destination of the in-vehicle device 201 has been changed.

In addition, upon reception, from the reception unit 41, of a notification that the user information has been received, the processing unit 33 performs the above-described “user registration process”, thereby updating the setting status table Tb10 stored in the storage unit 35.

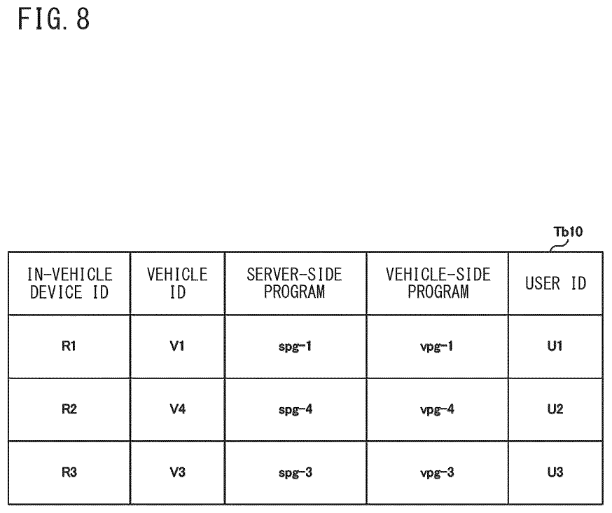

FIG. 8 shows an example of a setting status table updated by the server according to the embodiment of the present disclosure.

As shown in FIG. 8, the processing unit 33 associates the vehicle ID “V4” with the user ID “U2”. That is, the processing unit 33 changes the vehicle ID corresponding to the user ID “U2” from “V2” to “V4” in the setting status table Tb10.

When the ID correspondence relationship is not registered in the setting status table Tb10, the processing unit 33 may perform, in addition to the user registration process and the contact table update process, a process of outputting, to the transmission unit 43, disablement information that requests disablement of the transmission process performed by the in-vehicle device 201, i.e., the function of acquiring and transmitting vehicle information. The transmission unit 43 transmits the disablement information received from the processing unit 33, to the in-vehicle device 201.

With reference to FIG. 3 again, upon reception, from the processing unit 33, of a notification that the contact table Tb20 has been updated, and a notification that the ID correspondence relationship is not registered in the setting status table Tb10, the transmission unit 43 transmits installation information indicating that the in-vehicle device 201 having the received-identification information has been installed to the changed vehicle, to the user identified by the user ID corresponding to the vehicle ID received by the reception unit 41.

When the reception unit 41 has received the above-described “approval information” from the user as response information from the user to the installation information, the reception unit 41 outputs an approval reception notification to the processing unit 33, the setting unit 34, and the update request unit 42.

Upon reception of the approval reception notification from the reception unit 41, the processing unit 33 refers to the ID acquisition information stored in the storage unit 35 and confirms whether or not the in-vehicle device ID included in the ID acquisition information, i.e., the received-identification information, is registered in the setting status table Tb10. Here, it is assumed that the processing unit 33 has confirmed that the received-identification information is registered in the setting status table Tb10.

When the received-identification information is registered in the setting status table Tb10, the processing unit 33 performs a network confirmation process of confirming whether or not the configuration of the in-vehicle network (hereinafter, also referred to as “pre-change network”) in the vehicle 1 before the installation destination has been changed is the same as the configuration of the in-vehicle network (hereinafter, also referred to as “post-change network”) in the vehicle 1 after the installation destination has been changed.

For example, the management table Tb30 in the storage unit 35 includes the correspondence relationship between the configuration of an in-vehicle network in a vehicle 1 and a vehicle ID.

In the management table Tb30 shown in FIG. 6, the vehicle ID corresponding to an in-vehicle network configuration “N1” is “V1” and “V6”, the vehicle ID corresponding to an in-vehicle network configuration “N2” is “V2” and “V5”, the vehicle ID corresponding to an in-vehicle network configuration “N3” is “V3”, and the vehicle ID corresponding to an in-vehicle network configuration “N4” is “V4”.

With reference to FIG. 3 and FIG. 6, when the received-identification information is registered in the setting status table Tb10, the processing unit 33 refers to the setting status table Tb10 stored in the storage unit 35, and specifies a vehicle ID (hereinafter, also referred to as “registered vehicle ID”) corresponding to the received-identification information.

Then, the processing unit 33 refers to the management table Tb30 stored in the storage unit 35 and confirms whether or not the configuration of the pre-change network corresponding to the vehicle ID before the installation destination of the in-vehicle device 201 has been changed and the configuration of the post-change network corresponding to the changed-identification information are the same with each other. The processing unit 33 notifies the setting unit 34 and the update request unit 42 of the confirmation result.

Upon reception, from the processing unit 33, of a notification that the configuration of the pre-change network and the configuration of the post-change network are different from each other, the setting unit 34 performs the setting process. That is, when the configuration of the pre-change network and the configuration of the post-change network are different from each other, the setting unit 34 sets a computer program corresponding to the vehicle model specified by the changed-identification information, as the server-side program for processing, in the server 101, the vehicle information regarding the vehicle 1 in which the in-vehicle device 201 is installed.

Here, the in-vehicle network configuration in the vehicle 1 having the vehicle ID “V2” before the installation destination of the in-vehicle device 201 has been changed is “N2”, whereas the in-vehicle network configuration in the vehicle 1 having the vehicle ID “V4” after the installation destination has been changed is “N4”. That is, the configuration of the pre-change network and the configuration of the post-change network are different from each other. In this case, the setting unit 34 refers to the management table Tb30 stored in the storage unit 35 and sets, as the server-side program, the server-side program “spg-4” corresponding to the vehicle model “DDD” specified by the vehicle ID “V4”. The server-side program “spg-4” is an example of a third computer program.

Then, the setting unit 34 registers the specified server-side program in association with the changed-identification information, into the setting status table Tb10. As shown in FIG. 8, the setting unit 34 registers the server-side program “spg-4” in association with the vehicle ID “V4”.

Meanwhile, when the setting unit 34 has received, from the processing unit 33, a notification that the configuration of the pre-change network and the configuration of the post-change network are the same with each other, the setting unit 34 does not perform the setting process.

When the update request unit 42 has received, from the processing unit 33, a notification that the configuration of the pre-change network and the configuration of the post-change network are different from each other, the update request unit 42 performs the update requesting process. That is, when the configuration of the pre-change network and the configuration of the post-change network are different from each other, the update request unit 42 transmits, to the in-vehicle device 201, update request information for requesting update to a new vehicle-side program corresponding to the changed-identification information.

Here, the update request unit 42 refers to the management table Tb30 stored in the storage unit 35 and transmits, to the in-vehicle device 201, update request information for requesting update to the vehicle-side program “vpg-4” corresponding to the vehicle ID “V4”. Then, as shown in FIG. 6, the update request unit 42 registers the vehicle-side program “vpg-4” in association with the vehicle ID “V4”. The vehicle-side program “vpg-4” is an example of a fourth computer program.

Meanwhile, when the update request unit 42 has received, from the processing unit 33, a notification that the configuration of the pre-change network and the configuration of the post-change network are the same with each other, the update request unit 42 does not perform the update requesting process.

### Specific Example 2

When the setting unit 34 has received, from the processing unit 33, a notification that the configuration of the pre-change network and the configuration of the post-change network are the same with each other, the setting unit 34 does not perform the setting process. In the following, a case where the installation destination of the in-vehicle device 201 has been changed from the vehicle 1 having the vehicle ID “V2” to the vehicle 1 having the vehicle ID “V5” will be described as an example.

As described above, in the management table Tb30 shown in FIG. 6, the server-side program corresponding to the vehicle model “BBB” specified by the vehicle ID “V2” and the server-side program corresponding to the vehicle model “FFF” specified by the vehicle ID “V5” are “spg-2”.

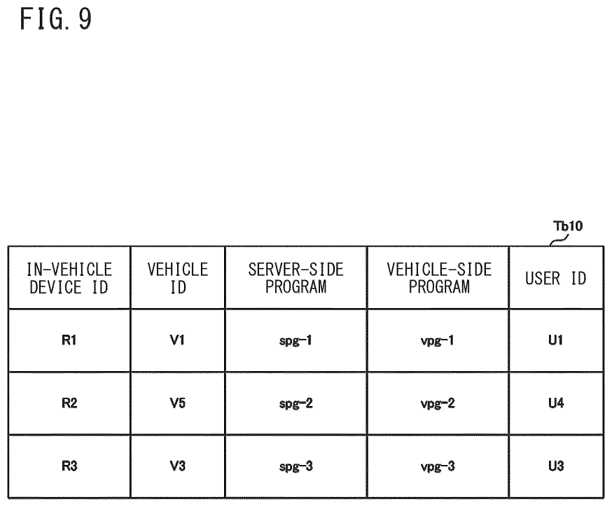

FIG. 9 shows another example of an updated setting status table according to the embodiment of the present disclosure.

In the setting status table Tb 10 shown in FIG. 9, the setting unit 34 maintains “spg-2” which is the same as the server-side program corresponding to the vehicle ID “V2”, as the server-side program corresponding to the vehicle ID “V5”. That is, even when the installation destination of the in-vehicle device 201 having the in-vehicle device ID “R2” has been changed, the setting unit 34 does not change and maintains the server-side program for processing the vehicle information received from the in-vehicle device 201.

When the update request unit 42 has received, from the processing unit 33, a notification that the configuration of the pre-change network and the configuration of the post-change network are the same with each other, the update request unit 42 does not perform the update requesting process.

More specifically, in the setting status table Tb10 shown in FIG. 9, the update request unit 42 maintains “vpg-2” which is the same as the vehicle-side program corresponding to the vehicle ID “V2”, as the server-side program corresponding to the vehicle ID “V5”. That is, even when the installation destination of the in-vehicle device 201 having the in-vehicle device ID “R2” has been changed, the update request unit 42 does not change and maintains the vehicle-side program for processing the vehicle information received from the in-vehicle device 201.

### Operation Flow

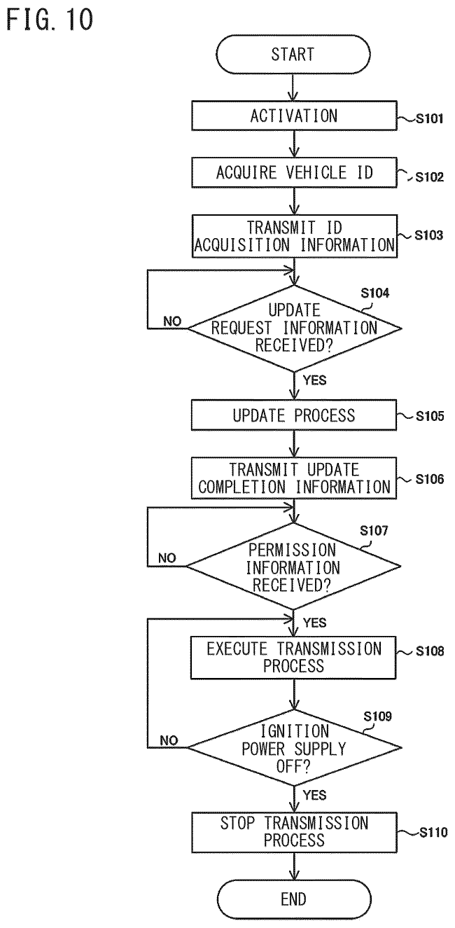

FIG. 10 is a flowchart of the operation procedure of a process performed by the in-vehicle device according to the embodiment of the present disclosure.

With reference to FIG. 10, first, when the ignition power supply of the vehicle 1 has been switched from an off-state to an on-state, the in-vehicle device 201 is activated (step S101).

Next, the in-vehicle device 201 acquires the vehicle ID from the vehicle 1 (step S102).

Next, the in-vehicle device 201 transmits ID acquisition information including the in-vehicle device ID thereof and the acquired vehicle ID, to the server 101 (step S103).

Next, when having received update request information from the server 101 (YES in step S104), the in-vehicle device 201 performs the update process of updating the vehicle-side program to a new vehicle-side program corresponding to the acquired vehicle ID, based on the update request information (step S105).

Next, the in-vehicle device 201 transmits the update completion information to the server 101 (step S106).

Next, until receiving, from the server 101, permission information that permits execution of the transmission process, the in-vehicle device 201 waits for execution of the transmission process (NO in step S107). When having received the permission information (YES in step S107), the in-vehicle device 201 performs the transmission process until the ignition power supply is switched from an on-state to an off-state (NO in step S109). For example, as described above, the in-vehicle device 201 executes the updated vehicle-side program, thereby acquiring vehicle information from the in-vehicle apparatus 211 and transmitting the acquired vehicle information to the server 101 (step S108).

Then, when the ignition power supply has been switched from an off-state to an on-state (YES in step S109), the in-vehicle device 201 stops the transmission process (step S110).

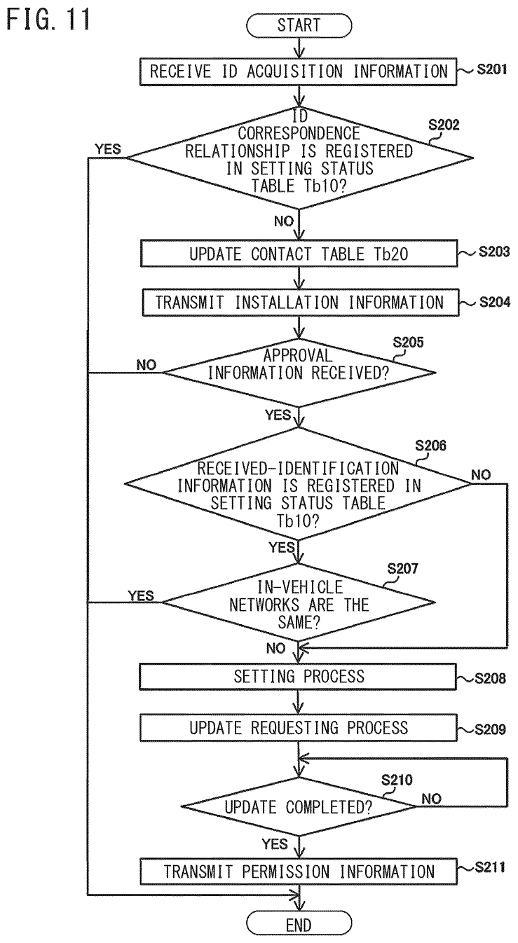

FIG. 11 is a flowchart indicating the operation procedure of the setting process and the update requesting process performed by the server according to the embodiment of the present disclosure.

With reference to FIG. 11, first, the server 101 receives ID acquisition information including the in-vehicle device ID and the vehicle ID from the in-vehicle device 201 (step S201).

Next, when the ID correspondence relationship between the in-vehicle device ID and the vehicle ID included in the received ID acquisition information is not registered in the setting status table Tb10 (NO in step S202), the server 101 updates the contact table Tb20 indicating the correspondence relationship between a vehicle ID and user information. For example, as described above, the server 101 transmits an information request notification for requesting user information, to the in-vehicle device 201. Then, the server 101 updates the contact table Tb20, based on the user information received from the in-vehicle device 201 (step S203).

Next, the server 101 transmits, to the user, installation information indicating that the in-vehicle device 201 having the in-vehicle device ID included in the received ID acquisition information, i.e., the received-identification information, has been installed in the vehicle 1. For example, as described above, the server 101 refers to the contact table Tb20 in the storage unit 35 and transmits the installation information to the user identified by the user ID corresponding to the vehicle ID included in the received ID acquisition information (step S204).

Next, when the server 101 has received approval information as response information from the user to the installation information (YES in step S205), the server 101 confirms whether or not the received-identification information is registered in the setting status table Tb10 (step S206).

Next, when the received-identification information is registered in the setting status table Tb10 (YES in step S206), the server 101 confirms whether or not the configuration of the pre-change network and the configuration of the post-change network are the same with each other (step S207).

Next, when the configuration of the pre-change network and the configuration of the post-change network are different from each other (NO in step S207), the server 101 performs the setting process. For example, as described above, the server 101 sets, as the server-side program, a computer program corresponding to the vehicle model specified by the changed-identification information (step S208).

Next, the server 101 performs the update requesting process. For example, as described above, the server 101 transmits, to the in-vehicle device 201, update request information that requests update to a new vehicle-side program corresponding to the changed-identification information (step S209). Step S208 and step S209 may be executed in a reversed order or may be executed in parallel.

Next, when the server 101 has received update completion information from the in-vehicle device 201 (YES in step S210), the server 101 transmits permission information to the in-vehicle device 201 (step S211).

Meanwhile, when received-identification information is not registered in the setting status table Tb10 (NO in step S206), the server 101 performs the setting process. For example, as described above, the server 101 sets, as the server-side program, a computer program corresponding to the vehicle model specified by the vehicle ID included in the received ID acquisition information (step S208).

Next, the server 101 performs the update requesting process. For example, as described above, the server 101 transmits, to the in-vehicle device 201, update request information that requests update to a new vehicle-side program corresponding to the vehicle ID included in the received ID acquisition information (step S209).

When the ID correspondence relationship is registered in the setting status table Tb10 (YES in step S202), when approval information cannot be received even after lapse of a certain time (NO in step S205), or when the configuration of the pre-change network and the configuration of the post-change network are the same with each other (YES in step S207), the server 101 does not perform the setting process and the update requesting process.

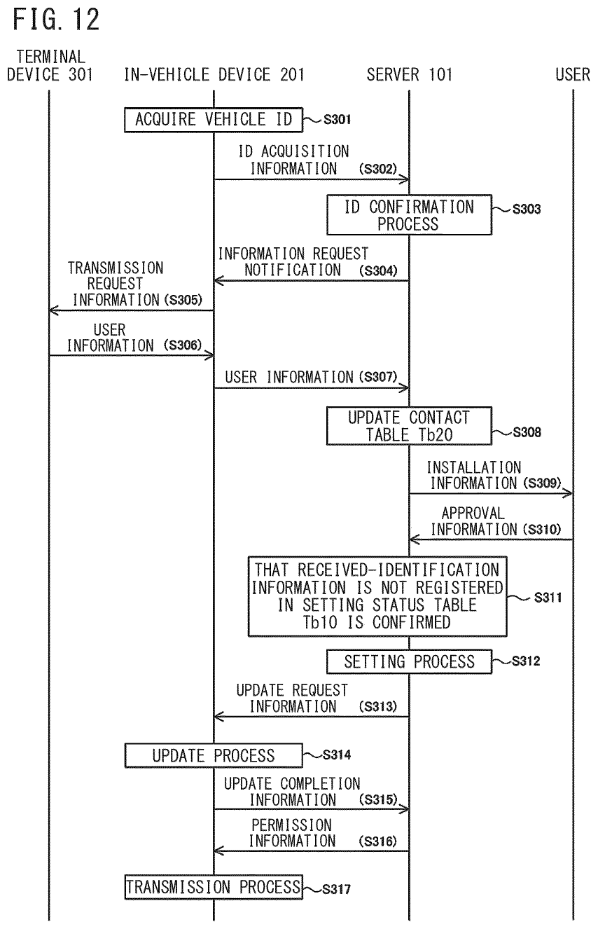

FIG. 12 shows an example of the sequence of processes performed by the server, the in-vehicle device, and the terminal device in the communication system according to the embodiment of the present disclosure.

With reference to FIG. 12, first, when an ignition power supply 72 of the vehicle 1 has been switched from an off-state to an on-state, the in-vehicle device 201 is activated and acquires, from the vehicle 1 in which the in-vehicle device 201 is installed, the vehicle ID of the vehicle 1 (step S301),

Next, the in-vehicle device 201 transmits ID acquisition information including the in-vehicle device ID thereof and the acquired vehicle ID, to the server 101 (step S302).

Next, the server 101 performs the ID confirmation process, based on the ID acquisition information received from the in-vehicle device 201. For example, as described above, the server 101 confirms whether or not the ID correspondence relationship between the in-vehicle device ID and the vehicle ID included in the received ID acquisition information is registered in the setting status table Tb10. Here, it is assumed that the ID correspondence relationship is not registered in the setting status table Tb10 (step S303).

Next, the server 101 transmits, to the in-vehicle device 201, information request notification for requesting user information regarding the user of the vehicle 1 (step S304).

Next, when having received, from the server 101, a notification that the information request notification has been received, the in-vehicle device 201 transmits, to the terminal device 301, transmission request information indicating that transmission of user information to the in-vehicle device 201 is requested (step S305).

Next, as a response to the information request notification received from the in-vehicle device 201, the terminal device 301 transmits user information to the in-vehicle device 201 (step S306).

Next, the in-vehicle device 201 transmits the user information received from the terminal device 301, to the server 101 (step S307).

Next, the server 101 updates the contact table Tb20, based on the ID acquisition information and the user information received from the in-vehicle device 201 (step S308).

Next, the server 101 transmits installation information indicating that the in-vehicle device 201 having the in-vehicle device ID included in the received ID acquisition information, i.e., the received-identification information, has been installed in the vehicle 1, to the user identified by the user ID corresponding to the vehicle ID included in the received ID acquisition information (step S309).

Next, as response information corresponding to the installation information received from the server 101, the user transmits, to the server 101, approval information indicating that connection between the vehicle 1 and the in-vehicle device 201 having the received-identification information is approved (step S310).

Next, the server 101 confirms whether or not the received-identification information is registered in the setting status table Tb10. Here, it is assumed that the server 101 has confirmed that the in-vehicle device ID included in the ID acquisition information is not registered in the setting status table Tb10 (step S311).

Next, the server 101 performs the setting process of setting, as the server-side program, a computer program corresponding to the vehicle model specified by the vehicle ID included in the received ID acquisition information (step S312).

Next, the server 101 performs the update requesting process of transmitting, to the in-vehicle device 201, update request information for requesting update to a new vehicle-side program corresponding to the vehicle ID included in the received ID acquisition information (step S313). Step S312 and step S313 may be executed in a reversed order or may be executed in parallel.

Next, based on the update request information received from the server 101, the in-vehicle device 201 performs the update process of updating the vehicle-side program stored therein, to a new vehicle-side program corresponding to the acquired vehicle ID (step S314).

Next, when having completed the update process, the in-vehicle device 201 transmits update completion information to the server 101 (step S315).

Next, when the setting process has been completed and the update completion information has been received from the in-vehicle device 201, the server 101 transmits, to the in-vehicle device 201, permission information indicating that execution of the transmission process by the in-vehicle device 201 is permitted (step S316).

Next, when having received the permission information from the server 101, the in-vehicle device 201 performs the transmission process by executing the updated vehicle-side program (step S317).

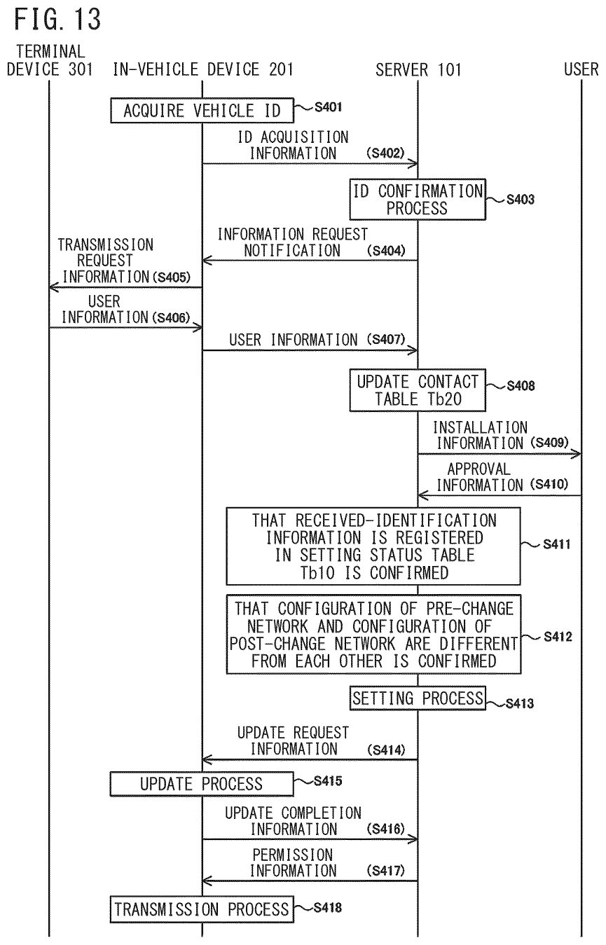

FIG. 13 shows another example of the sequence of processes performed by the server, the in-vehicle device, and the terminal device in the communication system according to the embodiment of the present disclosure.

The processes from step S401 to step S410 shown in FIG. 13 are respectively the same as the processes from step S301 to step S310 shown in FIG. 12.

Next, the server 101 confirms whether or not the received-identification information is registered in the setting status table Tb10. Here, it is assumed that the server 101 has confirmed that the received-identification information is registered in the setting status table Tb10 (step S411).

Next, the server 101 confirms whether or not the configuration of the pre-change network and the configuration of the post-change network are the same with each other. For example, as described above, it is assumed that the server 101 refers to the management table Tb30, and has confirmed that the configuration of the pre-change network and the configuration of the post-change network are different from each other (step S412).

Next, the server 101 performs the setting process of setting, as the server-side program, a computer program corresponding to the vehicle model specified by the vehicle ID included in the received ID acquisition information (step S413).

Next, the server 101 performs the update requesting process of transmitting, to the in-vehicle device 201, update request information for requesting update to a new vehicle-side program corresponding to the vehicle ID included in the received ID acquisition information (step S414). Step S413 and step S414 may be executed in a reversed order or may be executed in parallel.

The processes from step S415 to step S418 shown in FIG. 13 are respectively the same as the processes from step S314 to step S317 shown in FIG. 12.

In the server 101 according to the embodiment of the present disclosure, the transmission unit 43 is configured to transmit the installation information to the user identified by the user ID corresponding to the vehicle ID included in the ID acquisition information. However, the present disclosure is not limited thereto. The transmission unit 43 may be configured not to transmit the installation information to the user. In this case, when the setting unit 34 has received, from the processing unit 33, a notification that the ID correspondence relationship is not registered in the setting status table Tb10, the setting unit 34 performs the setting process. In addition, when the update request unit 42 has received, from the processing unit 33, a notification that the ID correspondence relationship is not registered in the setting status table Tb10, the update request unit 42 performs the update requesting process.

In the server 101 according to the embodiment of the present disclosure, the transmission unit 43 is configured to transmit permission information to the in-vehicle device 201, when the setting process by the setting unit 34 has been completed and the reception unit 41 has received update completion information from the in-vehicle device 201. However, the present disclosure is not limited thereto. For example, a configuration in which: the transmission unit 43 does not transmit permission information; and, upon completion of update of the second computer program, the in-vehicle device 201 starts the transmission process without transmitting update completion information, may be adopted.

A part or the entirety of the function of the server 101 according to the embodiment of the present disclosure may be provided by cloud computing. That is, the server 101 according to the embodiment of the present disclosure may be a cloud server configured by a plurality of servers.

The disclosed embodiment is merely illustrative in all aspects and should not be recognized as being restrictive. The scope of the present disclosure is defined by the scope of the claims rather than by the description above, and is intended to include meaning equivalent to the scope of the claims and all modifications within the scope.

Each process (each function) of the embodiment described above is realized by processing circuitry including one or a plurality of processors. The above processing circuitry may be configured as an integrated circuit or the like in which one or a plurality of memories, various analog circuits, and various digital circuits are combined, in addition to the one or the plurality of processors. The one or the plurality of memories have stored therein a computer program (command) that causes the one or the plurality of processors to execute the above processes. The one or the plurality of processors may execute the above processes according to the computer program that is read from the one or the plurality of memories, or may execute the above processes according to a logic circuit that is designed in advance to execute the above processes. The processors may be various processors conforming to control of a computer, such as a CPU (Central Processing Unit), a GPU (Graphics Processing Unit), a DSP (Digital Signal Processor), an FPGA (Field Programmable Gate Array), and an ASIC (Application Specific Integrated Circuit). The plurality of processors physically separated from each other may execute the above processes in cooperation with each other. For example, the processors respectively installed in a plurality of physically separated computers may execute the above processes in cooperation with each other via a network such as a LAN (Local Area Network), a WAN (Wide Area Network), and the Internet. The computer program may be installed in the memories via the network from an external server device or the like, or may be distributed in a state of being stored in a storage medium such as a CD-ROM (Compact Disc Read Only Memory), a DVD-ROM (Digital Versatile Disk Read Only Memory), or a semiconductor memory, and may be installed in the memories from the storage medium.

The above description includes the features in the additional notes below.

### Additional Note 1

A management device including:
a reception unit configured to receive vehicle identification information for identifying a vehicle, from an in-vehicle device installed in the vehicle;
a setting unit configured to perform a setting process of setting a computer program corresponding to a vehicle model specified by the vehicle identification information received by the reception unit, as a first computer program for processing, in the management device, vehicle information regarding the vehicle; and
an update request unit configured to perform an update requesting process of transmitting, to the in-vehicle device, update request information for requesting update to a second computer program that is a computer program corresponding to the vehicle identification information received by the reception unit and that is for the in-vehicle device to perform a transmission process of acquiring the vehicle information and transmitting the vehicle information to the management device, wherein
the reception unit further receives, from the in-vehicle device, device identification information for identifying the in-vehicle device,
the management device further includes
   a storage unit configured to store device correspondence information indicating a correspondence relationship between the device identification information and the vehicle identification information, and
the processing unit
   determines, when the device identification information is registered in the device correspondence information, that an installation destination of the in-vehicle device having the device identification information has been changed to the vehicle having the vehicle identification information received by the reception unit, and
   determines, when the device identification information is not registered in the device correspondence information, that the in-vehicle device having the device identification information has been installed in a vehicle for a first time.

### Additional Note 2

A management device including
processing circuitry, wherein
the processing circuitry
   receives vehicle identification information for identifying a vehicle, from an in-vehicle device installed in the vehicle,
   performs a setting process of setting a computer program corresponding to a vehicle model specified by the vehicle identification information having been received, as a first computer program for processing, in the management device, vehicle information regarding the vehicle, and
   performs an update requesting process of transmitting, to the in-vehicle device, update request information for requesting update to a second computer program that is a computer program corresponding to the vehicle identification information having been received and that is for the in-vehicle device to perform a transmission process of acquiring the vehicle information and transmitting the vehicle information to the management device.

### Additional Note 3

An in-vehicle device installed in a vehicle and configured to perform transmission and reception of information to and from a management device, the in-vehicle device including
processing circuitry, wherein
the processing circuitry
   acquires vehicle identification information for identifying the vehicle in which the in-vehicle device is installed,
   based on update request information received from the management device, the update request information being for requesting update to a computer program for the in-vehicle device to perform a transmission process of acquiring vehicle information regarding the vehicle and transmitting the vehicle information to the management device, performs an update process of updating the computer program stored in the in-vehicle device to a computer program that corresponds to the vehicle identification information having been acquired and that is a new computer program for performing the transmission process,
   performs the transmission process by executing the computer program having been updated, and
   when having completed the update process, transmits update completion information to the management device.

### REFERENCE SIGNS LIST

1 vehicle
11 first communication unit
12 setting processing unit
13 second communication unit
14 acquisition unit
21 reception unit
22 transmission processing unit
23 update unit
31 communication unit
32 analysis unit
33 processing unit
34 setting unit
41 reception unit
42 update request unit
43 transmission unit
51, 51A, 51B CAN bus
101 server
151 external network
201 in-vehicle device
211, 211A, 211B in-vehicle apparatus
212 vehicle ID storage unit
301 terminal device
501 communication system
Tb10 setting status table
Tb20 management table
Tb30 contact table

1. A management device comprising a processor programmed to perform operations comprising:
receiving vehicle identification information for identifying a vehicle, from an in-vehicle device installed in the vehicle;
performing a setting process of setting a computer program corresponding to the received vehicle identification information, as a first computer program for processing, in the management device, vehicle information regarding the vehicle; and
performing an update requesting process of transmitting, to the in-vehicle device, update request information for requesting update to a second computer program that corresponds to the received vehicle identification information, and that is for the in-vehicle device to perform a transmission process of acquiring the vehicle information and transmitting the vehicle information having been acquired, to the management device so as to be provided to the set first computer program.

2. The management device according to claim 1, wherein the receiving includes receiving changed-identification information transmitted from the in-vehicle device of which an installation destination has been changed, the changed-identification information being the vehicle identification information for identifying the vehicle in which the in-vehicle device is installed,
the performing the setting process includes setting a computer program corresponding to the changed-identification information, as a third computer program for processing, in the management device, vehicle information regarding the vehicle in which the in-vehicle device is installed, and
the performing the update requesting process includes transmitting, to the in-vehicle device, the update request information for requesting update to a fourth computer program that corresponds to the changed-identification information, and that is for the in-vehicle device to perform a transmission process of acquiring the vehicle information and transmitting the vehicle information having been acquired, to the management device so as to be provided to the set third computer program.

3. The management device according to claim 2, wherein
the performing the setting process includes, when a configuration of a pre-change network being an in-vehicle network in the vehicle before the installation destination has been changed and a configuration of a post-change network being the in-vehicle network in the vehicle after the installation destination has been changed are different from each other, setting a computer program corresponding to the changed-identification information as the third computer program, and
the performing the update requesting process includes, when the configuration of the pre-change network and the configuration of the post-change network are different from each other, transmitting, to the in-vehicle device, the update request information for requesting update to the fourth computer program corresponding to the changed-identification information.

4. The management device according to claim 1, wherein
the operations further comprises
transmitting, to the in-vehicle device, permission information indicating permission of execution of the transmission process by the in-vehicle device, when the setting process has been completed and the management device has received, from the in-vehicle device, update completion information indicating that update to the second computer program has been completed.

5. The management device according to claim 1, wherein
the receiving includes receiving, from the in-vehicle device, device identification information for identifying the in-vehicle device, and
the management device further comprises
a storage device configured to store therein user correspondence information indicating a correspondence relationship between user identification information for identifying a user of the vehicle and the vehicle identification information, and device correspondence information indicating a correspondence relationship between the device identification information and the vehicle identification information; and
the operations further comprises
when received-identification information being the received device identification information is not registered in the device correspondence information, transmitting, based on the user correspondence information in the storage unit device, installation information indicating that the in-vehicle device having the received-identification information has been installed in the vehicle, to the user identified by the user identification information corresponding to the received vehicle identification information.

6. The management device according to claim 5, wherein the performing the setting process includes performing the setting process when the reception unit has received, as response information from the user to the installation information, approval information indicating that connection between the vehicle and the in-vehicle device having the received-identification information is approved, and
the performing the update requesting process includes performing the update requesting process when the reception unit has received the approval information.

7. The management device according to claim 1, wherein
the receiving includes receiving, from the in-vehicle device, device identification information for identifying the in-vehicle device,
the management device further comprises
a storage device configured to store therein device correspondence information indicating a correspondence relationship between the device identification information and the vehicle identification information,
the performing the setting process includes performing the setting process when received-identification information being the received device identification information is not registered in the device correspondence information, and
the performing the update requesting process includes performing the update requesting process when the received-identification information is not registered in the device correspondence information.

8. The in-vehicle device configured to perform transmission and reception of information to and from the management device according to claim 1, the in-vehicle device comprising a processor programmed to perform operations comprising:
acquiring the vehicle identification information for identifying the vehicle in which the in-vehicle device is installed;
performing, based on the update request information received from the management device, an update process of updating a computer program stored in the in-vehicle device and for performing the transmission process, to the second computer program corresponding to the acquired vehicle identification information; and
performing the transmission process by executing the second computer program, wherein
the performing the update process includes, when having completed the update process, transmitting update completion information to the management device.

9. An in-vehicle device installed in a vehicle and configured to perform transmission and reception of information to and from a management device, the in-vehicle device comprising a processor programmed to perform operations comprising:
acquiring vehicle identification information for identifying the vehicle in which the in-vehicle device is installed;
performing, based on update request information received from the management device, the update request information being for requesting update to a computer program for the in-vehicle device to perform a transmission process of acquiring vehicle information regarding the vehicle and transmitting the vehicle information to the management device, an update process of updating the computer program stored in the in-vehicle device to a new computer program that corresponds to the acquired vehicle identification information and that is for performing the transmission process; and
a performing the transmission process by executing the computer program having been updated, wherein
the performing the update process includes, when having completed the update process, transmitting update completion information to the management device.

10. A management method to be performed in a management device, the management method comprising:
a step of receiving vehicle identification information for identifying a vehicle, from an in-vehicle device installed in the vehicle;
a step of performing a setting process of setting a computer program corresponding to the vehicle identification information having been received, as a first computer program for processing, in the management device, vehicle information regarding the vehicle; and
a step of performing an update requesting process of transmitting, to the in-vehicle device, update request information for requesting update to a second computer program that corresponds to the vehicle identification information having been received, and that is for the in-vehicle device to perform a transmission process of acquiring the vehicle information and transmitting the vehicle information having been acquired, to the management device so as to be provided to the first computer program set in the management device.

11. A computer-readable non-transitory storage medium having stored therein a management program to be used in a management device, the management program causing a processor to perform operations:
receiving vehicle identification information for identifying a vehicle, from an in-vehicle device installed in the vehicle;
performing a setting process of setting a computer program corresponding to the received vehicle identification information, as a first computer program for processing, in the management device, vehicle information regarding the vehicle; and
performing an update requesting process of transmitting, to the in-vehicle device, update request information for requesting update to a second computer program that corresponds to the received vehicle identification information and that is for the in-vehicle device to perform a transmission process of acquiring the vehicle information and transmitting the vehicle information having been acquired, to the management device so as to be provided to the set first computer program.

12. The management device according to claim 2, wherein
the operations further comprises
transmitting, to the in-vehicle device, permission information indicating permission of execution of the transmission process by the in-vehicle device, when the setting process has been completed and the management device has received, from the in-vehicle device, update completion information indicating that update to the second computer program has been completed.

13. The management device according to claim 3, wherein
the operations further comprises
transmitting, to the in-vehicle device, permission information indicating permission of execution of the transmission process by the in-vehicle device, when the setting process has been completed and the management device has received, from the in-vehicle device, update completion information indicating that update to the second computer program has been completed.

14. The management device according to claim 2, wherein
the receiving includes receiving, from the in-vehicle device, device identification information for identifying the in-vehicle device, and
the management device further comprises
a storage device configured to store therein user correspondence information indicating a correspondence relationship between user identification information for identifying a user of the vehicle and the vehicle identification information, and device correspondence information indicating a correspondence relationship between the device identification information and the vehicle identification information; and
the operations further comprises
when received-identification information being the received device identification information is not registered in the device correspondence information, transmitting, based on the user correspondence information in the storage unit device, installation information indicating that the in-vehicle device having the received-identification information has been installed in the vehicle, to the user identified by the user identification information corresponding to the received vehicle identification information.

15. The management device according to claim 3, wherein
the receiving includes receiving, from the in-vehicle device, device identification information for identifying the in-vehicle device, and
the management device further comprises
a storage device configured to store therein user correspondence information indicating a correspondence relationship between user identification information for identifying a user of the vehicle and the vehicle identification information, and device correspondence information indicating a correspondence relationship between the device identification information and the vehicle identification information; and
the operations further comprises
when received-identification information being the received device identification information is not registered in the device correspondence information, transmitting, based on the user correspondence information in the storage unit device, installation information indicating that the in-vehicle device having the received-identification information has been installed in the vehicle, to the user identified by the user identification information corresponding to the received vehicle identification information.

16. The management device according to claim 4, wherein
the receiving includes receiving, from the in-vehicle device, device identification information for identifying the in-vehicle device, and
the management device further comprises
a storage device configured to store therein user correspondence information indicating a correspondence relationship between user identification information for identifying a user of the vehicle and the vehicle identification information, and device correspondence information indicating a correspondence relationship between the device identification information and the vehicle identification information; and
the operations further comprises
when received-identification information being the received device identification information is not registered in the device correspondence information, transmitting, based on the user correspondence information in the storage unit device, installation information indicating that the in-vehicle device having the received-identification information has been installed in the vehicle, to the user identified by the user identification information corresponding to the received vehicle identification information.

17. The management device according to claim 2, wherein
the receiving includes receiving, from the in-vehicle device, device identification information for identifying the in-vehicle device,
the management device further comprises
a storage device configured to store therein device correspondence information indicating a correspondence relationship between the device identification information and the vehicle identification information,
the performing the setting process includes performing the setting process when received-identification information being the received device identification information is not registered in the device correspondence information, and
the performing the update requesting process includes performing the update requesting process when the received-identification information is not registered in the device correspondence information.

18. The management device according to claim 3, wherein
the receiving includes receiving, from the in-vehicle device, device identification information for identifying the in-vehicle device,
the management device further comprises
a storage device configured to store therein device correspondence information indicating a correspondence relationship between the device identification information and the vehicle identification information,
the performing the setting process includes performing the setting process when received-identification information being the received device identification information is not registered in the device correspondence information, and
the performing the update requesting process includes performing the update requesting process when the received-identification information is not registered in the device correspondence information.

19. The management device according to claim 4, wherein
the receiving includes receiving, from the in-vehicle device, device identification information for identifying the in-vehicle device,
the management device further comprises
a storage device configured to store therein device correspondence information indicating a correspondence relationship between the device identification information and the vehicle identification information,
the performing the setting process includes performing the setting process when received-identification information being the received device identification information is not registered in the device correspondence information, and
the performing the update requesting process includes performing the update requesting process when the received-identification information is not registered in the device correspondence information.

20. The management device according to claim 5, wherein
the receiving includes receiving, from the in-vehicle device, device identification information for identifying the in-vehicle device,
the management device further comprises
a storage device configured to store therein device correspondence information indicating a correspondence relationship between the device identification information and the vehicle identification information,
the performing the setting process includes performing the setting process when received-identification information being the received device identification information is not registered in the device correspondence information, and
the performing the update requesting process includes performing the update requesting process when the received-identification information is not registered in the device correspondence information.
